(19) United States
(12) Patent Application Publication
(10) Pub. No.: US 2009/0287513 A1
(43) Pub. Date: Nov. 19, 2009

(54) System and method for processing multiple bookings to receive a transportation service

(75) Inventors: Denise M. Anderson, New Market, MN (US); James Gibson, Apple Valley, MN (US); David W. Rohy, Darwin, MN (US); Donna L. Sundstrom, Prior Lake, MN (US); Sajeendra Prasad Anjasa Janardanan, Bangalore (IN)

Correspondence Address: UNISYS CORPORATION, UNISYS WAY, MAIL STATION: E8-114, BLUE BELL, PA, 19424, US

(73) Assignee: Unisys Corporation

(21) Appl. No.: 11/474,009

(22) Filed: Jun. 23, 2006

(51) Int. Cl. G06Q 50/00; G06F 15/16; G06Q 10/00; G06Q 30/00

(52) U.S. Cl. 705/6; 707/3; 705/26; 707/103 Y; 707/E17.014; 707/E17.044; 707/E17.045

(57) ABSTRACT

A system and method for use by a transportation service provider to process multiple bookings in a single transaction. This single-transaction processing can be initiated to place passengers of multiple bookings on a same flight, to seat passengers of multiple bookings next to one another, or to reserve special services for passengers of multiple bookings. This mechanism is supported by a user interface that allows multiple bookings to be “visually merged”. This provides a display that presents data for multiple bookings as though that data is part of a same booking, and which readily allows a user to initiate processing of the data during a single transaction.

### RELATED APPLICATIONS

The following commonly-assigned Patent Applications have some subject matter in common with the current Application:

Ser. No. ______ filed on even date herewith entitled “System and Method for Booking and Re-booking Passengers on a Transportation Service”, Attorney Docket Number RA-5807.

### FIELD OF THE INVENTION

The present invention relates generally to a system and method for booking passengers on transportation carriers; and more particularly, to a transportation system and method for processing multiple bookings in parallel with one another.

### BACKGROUND OF THE INVENTION

Transportation carriers such as airlines, trains, bus companies and the like generally employ some type of reservation and departure control system. Such systems are used to book passengers, track baggage, and manage departures and arrivals. These types of systems also rebook and/or reseat customers because of travel events such as cancelled or delayed flights.

Reservation and departure control systems process and manage passengers using “booking data”. Booking data is defined as all of the information about a passenger or a group of passengers that are traveling together on the same trip. Such information, sometimes referred to simply as “a booking”, includes passenger names, the number of segments in the journey, the transportation routes (e.g., flight segments) included within the journey, and any special requirements such as special meals, wheelchairs, etc. that may be needed by one or more of the members in the party. It may further include car rental and hotel information, the manner in which the passengers are being ticketed, data regarding travel documents, contact and payment information, and information regarding any other accommodation or service associated with the journey.

Data is generally updated and managed on a booking basis. For example, when passengers first purchase space on a flight, a booking is created that indicates the type and amount of space purchased. The data for this booking may be stored as a separate file or record in a repository, for instance. If seats are then assigned, this assignment generally occurs for a given booking without regard to any passengers in other bookings.

In some cases, after two or more booking are created in the foregoing manner, a request may be received to perform some type of operation on behalf of passengers of multiple bookings. As an example, this request may involve seating passengers of multiple bookings with one another. According to prior art mechanisms, this request can only be honored in a serial fashion. In other words, the passengers of a first booking are accommodated as a group. Then the passengers included in a second booking are accommodated in a manner that makes an attempt to seat those passengers with the passengers of the first booking. This may, or may not, be possible since intervening requests made on behalf of other passengers in unrelated bookings may have resulted in unavailability of seats that had been intended for use in accommodating that second booking.

The same type of scenario occurs when any other type of request is received that involves multiple bookings. For instance, a request may be received to order vegetarian meals for people in multiple bookings. The travel representative must process each of the affected bookings one-by-one. There is no mechanism in the prior art for processing the bookings together.

As may be appreciated, the type of serial processing described above is tedious and time-consuming. Moreover, such processing can only be initiated via manual intervention, as by a travel agent who receives the request. There is no way to automatically handle the processing of requests that involve multiple bookings.

The limitations associated with the initial processing of multiple bookings also hinder the handling of passengers for re-accommodation purposes. Such re-accommodation may be necessary after a travel event such as a flight cancellation occurs. In this case, multiple substitute flights may be used to re-accommodate the affected passengers. Assume passengers from two different bookings want to travel together on the same substitute flight for one or more legs of their journey. Prior art systems cannot readily handle these types of requests because passengers from one booking are processed independently of those from another in the serial fashion discussed above. Generally, to ensure that such serial processing will be performed to the customer's satisfaction, manual intervention and multiple processing iterations are required.

What is needed, therefore, if an improved system and method for processing multiple bookings in a manner that solves the foregoing problems.

### SUMMARY OF THE INVENTION

The current invention provides a system and method for allowing multiple bookings to be processed during a single transaction as though they are part of the same booking. This processing can be performed to place passengers of multiple bookings on a same flight, to seat passengers of multiple bookings with one another, to reserve special services (e.g., special meals, use of a bassinet or wheelchair, etc.) for passengers of multiple bookings, to add comment or contact information to multiple bookings at once, or to perform any operation on the multiple bookings that could otherwise be performed on a single booking. This mechanism can be used not only during the initial trip-planning process, but also may be used to re-accommodate passengers of multiple bookings on a same alternative flight after a travel event requires the change of travel plans.

During the processing of multiple bookings, the data for all of the bookings is first retrieved from storage. Typically, this involves retrieving a respective record from a database for each of the bookings. All of the retrieved data is then merged and subsequently handled as though that data is part of the same booking. That is, a single request is made to obtain a service needed to satisfy the requirements of all of the passengers for all of the retrieved bookings. In one case, this may involve obtaining the required space for all passengers to travel together on a same flight for one or more segments of their trip. Alternatively, or additionally, this may involve seating one or more passengers next to one another. This might also involve booking special services for one or more passengers.

When all required processing for all of the bookings that have been merged has been completed in a satisfactory manner, the individual bookings are updated, as may occur by updating respective records of a database. This updating of multiple booking records occurs during a single transaction.

In one embodiment, when multiple bookings are processed together in the foregoing manner, they are each assigned one or more identifiers that allow these bookings to be cross-referenced. These identifiers may include a Booking Association Number (BAN), which is a number that is stored within each of the bookings to record that the booking was previously merged with one or more other bookings. In another embodiment, pointers are stored to cross-reference the bookings to one another. Yet another scenario stores the confirmation numbers for other bookings that are cross-referenced with a current booking in the record for the current booking. In any embodiment, these identifiers may be employed to automatically cause these previously-merged bookings to again be merged for future processing purposes.

The current system and method provides a user interface that allows multiple bookings to be “visually merged”. According to this interface, a user such as an airline or travel agent identifies multiple bookings that are to be merged. The information from these bookings is retrieved from a database or other repository. This information is then merged within a display screen and is displayed as though it is part of a single booking.

Merging data for multiple bookings into a single consolidated display according to the current invention makes it much easier for a travel representative to determine, at a glance, what services and passengers are currently listed in those bookings. In prior art systems, the only way to view data for multiple bookings is to toggle between two or more display screens, each of which is associated with a respective booking. This is cumbersome, and may require a user to remember data as he or she toggles from screen-to-screen.

After data for multiple bookings is visually merged within a single display screen, the user is provided with an opportunity to select one or more transportation routes (e.g., flights) and one or more passengers from this “merged booking” information. The user further identifies a service that is to be provided. The service is then reserved for all selected passengers on the selected routes during a single transaction, as would occur if all of the selected passengers were part of the same booking. This single-transaction processing generally yields satisfactory results without the need for multiple processing iterations, saving human and system resources.

If the results of the above-described processing are satisfactory (e.g., the flight and/or seat assignments are acceptable), the individual bookings that had been included in the merged booking process are updated to reflect the new service(s). While making the updates, the bookings that were merged are cross-referenced with one another, as may be accomplished using a BAN and/or some other identifiers such as pointers, as described above.

As previously discussed, the types of services that may be selected via the user interface of the current invention include any type of service provided by the carrier. For instance, the service may involve placing all passengers of the merged booking on a same flight so that they may travel together. This may involve canceling one or more of the flights that had originally been booked for these passengers with a flight that can accommodate all passengers of all of the bookings. In another case, the service may seat one or more passengers of the multiple bookings next to one another. In yet another example, the service may provide selected passengers of multiple bookings with special meals, pre-boarding privileges, aisle seats, use of a wheelchair or bassinet, or with any other service or amenity provided by the carrier.

The current invention is supported by a database organized as one or more relational tables. This allows bookings to be retrieved using any one or more primary key or secondary index fields that have been selected as being searchable. This is an improvement over prior art RDCS databases which utilize flat file organizational structures, and which require a search to be initiated using a unique file identifier such as a confirmation number. In such systems, if the confirmation number is not known, as is often the case when performing processing after the booking is originally created, a brute-force search must be initiated to locate the file. This is extremely time-consuming. In contrast, the relational table structure of the current RDCS allows any one or more booking or passenger characteristics to be made searchable so that these fields can be used to specify records for inclusion in the visual merge process. This makes the retrieval of multiple previously-created bookings much more efficient, thereby making use of the visual merge process viable.

According to one embodiment, a computer-implemented method for managing passengers of a transportation carrier is disclosed. The method includes providing a user interface to allow a user to identify multiple bookings, and then merging data for the multiple bookings on a display screen. The method further includes allowing the user to select an operation to be performed on the multiple bookings, and performing the operation on the multiple bookings as though the multiple bookings were a single booking.

In one embodiment, the operation to be performed on the multiple bookings is selected from a group consisting of placing passengers of the multiple bookings on the same transportation route (e.g., the same flight), assigning seats so that one or more of the passengers of the multiple bookings may sit together, requesting a special meal for one or more of the passengers of the multiple bookings, reserving use of some other service (e.g., bassinet, wheelchair, etc.) for one or more of the passengers of the multiple bookings, adding a comment to the multiple bookings, making a ticketing arrangement for the multiple bookings, and adding contact information to the multiple bookings.

Also provided is a system for managing passengers of a transportation carrier. The system includes a booking module for creating multiple bookings, each scheduling one or more passengers to receive one or more services provided by the transportation carrier. The system further comprises a storage facility to store the multiple bookings. The system includes one or more user interface modules coupled to the storage facility to retrieve at least two of the multiple bookings, to merge the at least two retrieved bookings, and to allow an operation to be performed on the merged bookings at once as though the merged bookings were a single booking.

Another embodiment of the invention relates to a system for managing passengers of a transportation carrier. The system includes database means for storing multiple bookings, each scheduling one or more passengers for a trip, and user interface means for retrieving at least two of the multiple bookings, for merging the retrieved bookings, and for performing an operation on the merged bookings at once.

Many other aspects of the current invention will become apparent to those skilled in the art from the following description and the accompanying drawings.

### BRIEF DESCRIPTION OF THE DRAWINGS

FIG. 1 is a block diagram of one embodiment of a Reservation and Departure Control System (RDCS) according to the current invention.

FIG. 2 is a block diagram illustrating an exemplary embodiment of the Reservation and Departure Control System in further detail.

FIG. 3 is a block diagram illustrating one method of processing multiple bookings in a serial manner.

FIG. 4 is a block diagram that illustrates the manner in which multiple bookings may be processed in a parallel manner.

FIG. 5 is a block diagram illustrating one serial method of re-booking passengers to an alternative flight after the occurrence of a travel event.

FIG. 6 is a block diagram of one mechanism of re-bookings passengers according to one embodiment of the current invention following the occurrence of a travel event.

FIG. 7 is one embodiment of a screen display for use in invoking various functions supported by the RDCS.

FIG. 8 is a screen display that is provided after an agent selects the Merge Booking function.

FIG. 9 is a screen display provided after two bookings have been visually merged according to the current invention.

FIG. 10 is a screen display that is provided to allow an agent to reserve services for all passengers of a merged booking.

FIG. 11 is a screen display after the Booking Tab has been selected following reservation of a service for a merged booking.

FIG. 12 is a screen display that is provided whenever a user retrieves a booking that has previously been merged within another booking using the above-described process.

FIG. 13 is a screen display that is provided to book a passenger on a specific flight after a previous flight has been cancelled.

FIGS. 14A and 14B, when arranged as shown in FIG. 14, are a flow diagram of one computer-implemented method according to the current invention.

### DETAILED DESCRIPTION OF THE DRAWINGS

### I. System Environment

Before considering the invention in detail, a description of an exemplary Reservation and Departure Control System (RDCS) that may employ the current invention is provided for discussion purposes. It will be understood that the described system is provided by way of example only. Many other types of systems and system architectures may usefully employ the current invention. Additionally, while the following discussion references the airlines industry, it will be understood that this is merely for exemplary purposes, and that the RDCS may be adapted for use with any transportation provider, such as a bus company, a cruise line, a train service, and so on.

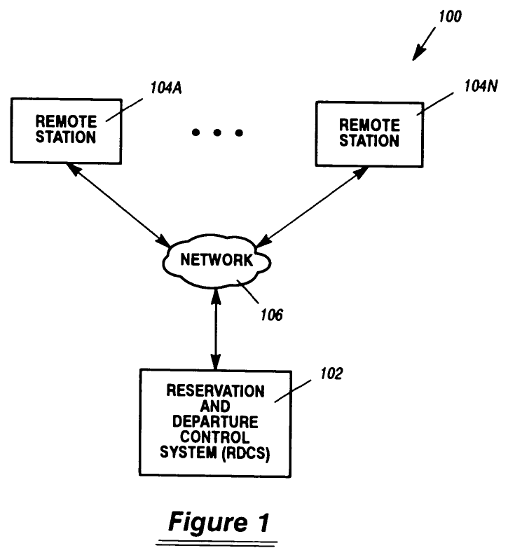

FIG. 1 is a block diagram illustrating an exemplary computing environment 100 in which an RDCS 102 provides management and control services to a transportation carrier such as an airline. The services provided by RDCS may include registration and check-in functions as well as re-booking activities. In particular, RDCS provides re-booking services as may be required when transportation routes are cancelled, re-scheduled, or otherwise modified. According to the current invention, services are performed in a manner that allows passengers from multiple bookings to be processed together as a unit. The results of the processing are then stored back to the respective bookings. This allows customers from multiple bookings to receive selected booking, check-in, and re-accommodation services as though the passengers were part of the same booking. These types of activities may be completed automatically.

As described in detail herein, RDCS 102 provides a user interface to allow authorized users residing at remote stations 104A-104N (“remote stations 104”) to perform a number of tasks associated with re-booking flights and performing other related tasks. A user may be, for example, front-line staff, a system administrator, a control agent, or other authorized users. Exemplary tasks include retrieving basic customer data, retrieving customer data associated with cards such as credit cards and frequent flyer cards, initiating re-booking activities such as re-booking a customer that has missed a flight, retrieving customer notification contact data, and so on. Remote stations 104 may be associated with a single airline or multiple airlines.

RDCS 102 presents a user interface, which may be a graphical set of interrelated screens (not shown) that allow the users to initiate booking, check-in and re-accommodation activities for one or more flights. A user, such as front-line staff residing at one of remote stations 104, may submit a request to perform such activities, or such requests may be submitted automatically by one of the RDCS modules, as described below.

In one embodiment, each of the users associated with remote stations 104 accesses RDCS 102 via a network 106 using a remote computing device having suitable communication software such as a web browser. Network 106 may be any private or public network, and may include one or more Local Area Networks (LANs), Wide Area Network (WANs), wireless LANs or the like. Network 106 may also include one or more connected network devices (not shown), such as personal computers, laptop computers, handheld computers, workstations, servers, routers, switches, printers, fax machines or other devices.

A user may access RDCS 102 using a network-enabled computing device, such as a workstation, personal computer, laptop computer or a handheld device. The communication device executes the communication software in order to communicate with RDCS 102.

Remote stations 104 may include remote stations located in a single airport or, more likely, remote stations located in multiple airports. In addition, one or more remote stations 104 may be located outside of the airport environment. For example, one or more remote stations may be located within hotels, travel agencies or other locations. In another example, a user (e.g., a customer) may remotely access RDCS 102 via the Internet from a computing device located within a home or another location. Alternatively, a user may access RDCS 102 via a self-check-in terminal within an airport or other location. In still another embodiment, remote stations may be located at the same facility as RDCS 102.

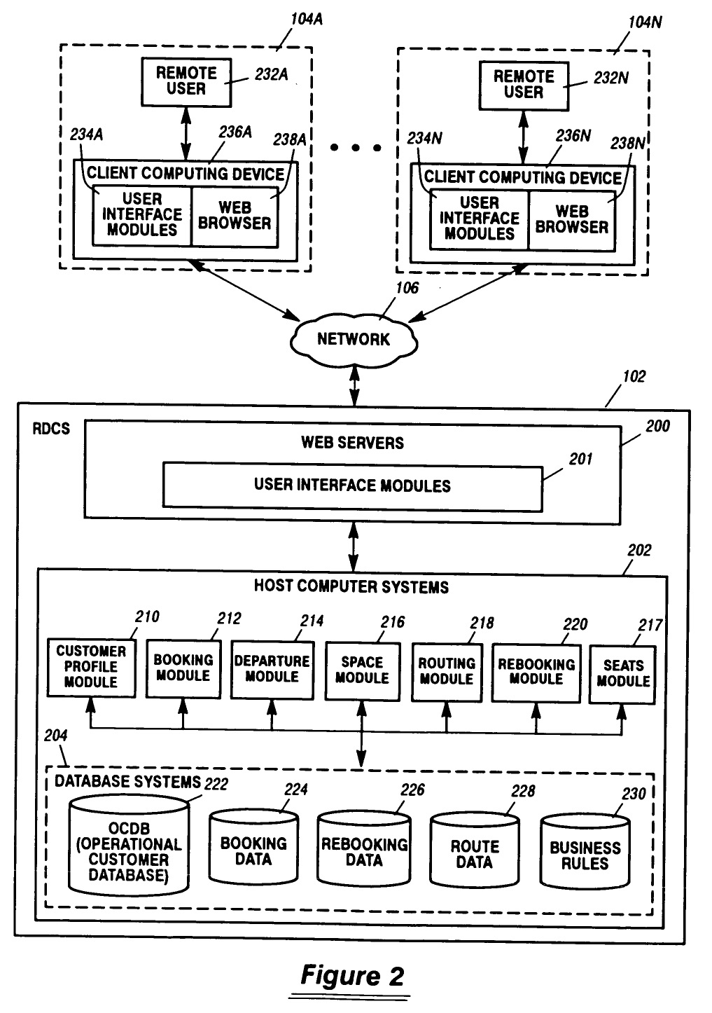

FIG. 2 is a block diagram illustrating an exemplary embodiment of RDCS 102 for hosting management services for one or more airline carriers. In the exemplary embodiment, RDCS 102 includes one or more web servers 200 coupled to host computer systems 202. Host computer systems 202 may include one or more servers executing the UNIX, Linux, Windows®, or any other operating system. Host computer systems 202 provide database systems 204 for storing data. Example database systems include SQL Server™ from Microsoft Corporation and the Oracle™ database from Oracle Corporation. Although illustrated separately, web servers 200 and host computer systems 202 may be integrated, and/or provided by one or more computing systems.

Host computer systems 202 execute software service modules 210-220. These service modules generally represent software modules having executable instructions to assist airline personnel in providing airline services. In this example, host computer systems 202 execute a customer profile module 210, a booking module 212, a departure module 214, a space module 216, a routing module 218, a rebooking module 220, and a seats module 217.

Customer profile module 210 allows a user to create, retrieve, and update customer profile data, which is stored within an Operational Customer Database (OCDB) 222. OCDB 222 provides a centralized repository for maintaining consistent, current customer data for use by any of the service modules 210-220 executed by host computer systems. Customer data may include customer contact data, customer preferences such as seating and meal preferences, preferred connection points, hotel and vehicle preferences, frequent flier information, billing and payment information, customer requirements and special requests (e.g., wheelchair requirements, special meal requests, etc.) and so on.

Turning next to booking module 212, this module receives and manages the booking data associated with airline flights. Booking data is defined as all of the information about a passenger or a group of passengers that are traveling together on the same journey. Such information, sometimes referred to simply as “a booking”, includes passenger names, which one or more flights are included within the journey, and any special requirements such as special meals, wheelchairs, etc. that may be needed by one or more members in the party. It may further include car rental and hotel information, the manner in which the passengers are being ticketed, data regarding travel documents, contact and payment information, and information regarding any other accommodation or service associated with the journey. This data is stored as booking data 224 within database systems 204.

Departure module 214 manages the check-in process on the day of departure, including the check-in of passengers and baggage. For example, an airline employee, shown as one of remote users 232A-232N, may interact with departure module 214 to obtain the issuance of boarding passes and bag tags, and to manage standby passengers. In addition, a remote user may indicate any special needs and requests required by passengers as identified during the check-in process.

Space module 216 manages information regarding the space that is available on flights provided by the current carrier. For instance, this module controls sales restrictions for flights. This module may be coupled to an external space module (not shown), which provides information on space available on flights provided by other carriers. Another related module, seats module 217, provides information on the layout of each aircraft, including information concerning the seating configurations.

Routing module 218 utilizes predetermined flight data (not shown in FIG. 2) that describes the flights provided by the airline to determine the various route options that are available to customers. For example, routing module will determine the best way for a customer to travel from a desired departure location to a destination point using the flights hosted by this airline, or one or more other airlines.

Finally, re-booking module 220 is used to re-book passengers on alternative flights. For example, remote users 232 may interact with re-booking module 220 to re-book passengers following an event such as a schedule change, equipment change, delay in arrival or departure, cancellation, misconnection, a route change, or any other contingency. Re-booking module 220 also re-books passengers because of requests issued automatically by other modules in the system, as will be discussed below. Data maintained by re-booking module to accomplish these types of re-booking activities is shown as re-booking data 226.

Host computer systems 202 may include other service modules (not shown) that are coupled to OCDB 222, including a ticketing module for managing ticketing activity, an information module for managing automated information such as visa requirements, ticketing rules, luggage policies and procedures, fare rules, promotions and the like, an agreement module to store agreements that exist between an airline and its partners, and a load control module for assisting airline load control agents in planning the distribution of payload aboard an aircraft.

Web servers 200 provide a seamless interface by which remote users 232A-232N or local users (not shown) may access host computer systems 202. Although host computer systems 202 and web servers 200 are illustrated separately in FIG. 2 for exemplary purposes, RDCS 102 may be realized by a single computing device or a plurality of cooperating computing devices such as a clustered computing architecture.

According to the exemplary embodiment of FIG. 2, web servers 200 provide a web-based interface by which authorized remote users 232A-232N communicate with RDCS 102 via network 106. In one configuration, web servers 200 execute web server software, such as software marketed by Microsoft Corporation under the trade designation “INTERNET INFORMATION SERVER.”As such, web servers 200 provide an environment for executing user interface modules 201. User interface modules 201 provide an interface that allows users 232A-232N to manage airline reservations, check-in, and re-booking functions. User interface modules 201 may include Active Server Pages, web pages written in hypertext markup language (HTML) or dynamic HTML, Active X modules, Java scripts, Java Applets, Distributed Component Object Modules (DCOM), and the like.

User interface modules 201 may execute within an operating environment provided by web servers 200. Alternatively, portions of user interface modules 201 may be downloaded as “client-side” user interface modules 234A-234N that are executed on client computing devices 236A-236N, respectively. Client-side user interface modules 234A-234N could, for example, include Active X components or Java scripts executed by web browsers 238A-238N running on client computing devices 236A-236N, respectively.

It will be understood that the RDCS shown in FIG. 2 is exemplary only. Other systems may include fewer or more modules, may omit or add functionality, and/or may implement similar functionality in alternative ways. Thus, FIG. 2 should be considered as only one of many types of systems that may usefully employ the current invention.

As will be described in detail, according to the current invention, RDCS provides an environment that allows passengers from multiple bookings to be processed as though they are part of the same booking for specially-requested purposes. Results of this activity are then stored back to the respective records within databases 204, as will be described below.

### II. Description of Exemplary Embodiments of the Invention

As discussed above, the system of FIGS. 1 and 2 provides booking, check-in, and re-booking services for a transportation carrier such as an airline. These services can be performed in a serial manner. Alternatively, the services can be provided in a more optimal parallel manner according to the current invention, as will be discussed in relation to the remaining Figures.

A. Booking Operations

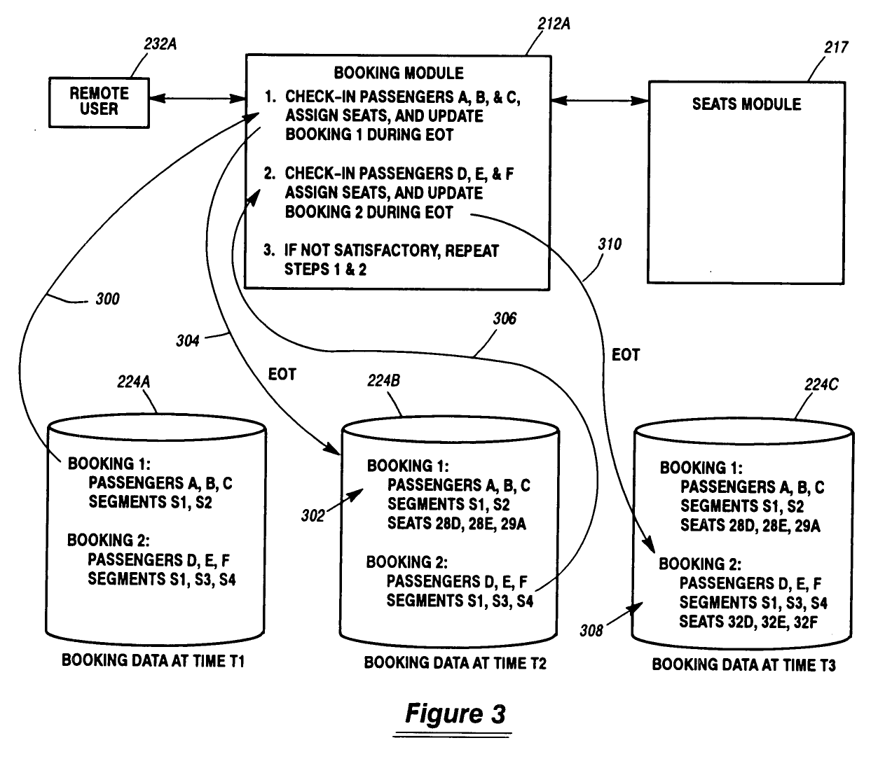

FIG. 3 is a block diagram that illustrates the manner in which multiple bookings may be processed in a serial manner via booking module 212A, which is adapted to perform this type of serial operation.

In this example, booking module 212A has already created a first booking, booking 1, for passengers A, B, and C who are traveling together on flight segments S1 and S2. For instance, segment S1 may be a flight from Minneapolis to Chicago, and flight S2 may be a flight from Chicago to Washington D.C. Information about booking 1 was created when the seats were sold to passengers A, B, and C. This data may be stored within booking data 224 of database systems 204, for instance.

In a like manner, assume that booking module 212A has created a second booking, booking 2, for passengers D, E, and F. These passengers are traveling together on flight segments S1, S3, and S4. This may include, for instance, the same flight from Minneapolis to Chicago on which the first group of passengers is also traveling. Segments S3 and S4 may include a flight from Chicago to Miami, and a flight from Miami to Caracas, respectively. When these seats were sold to passengers D, E, and F, the data for this booking is likewise stored within booking data 224 of database systems 204.

Assume at time T1, bookings 1 and 2 exist as independent, entirely unrelated records within booking data 224 of database systems 204. This booking data is shown at time T1 as booking data 224A in FIG. 3.

Next, assume that sometime after the two bookings have been created, seat assignments are being made. Further assume that passenger C of booking 1 and passenger D of booking 2 would like to sit together on the first segment S1 of their journeys. This request is made to a travel agent represented as remote user 232A. In response, this remote user submits a request to RDCS 102, as via network 106 (FIG. 1).

As mentioned above, booking module 212A is a prior art system adapted to handle the current type of request in a serial manner. Specifically, booking module 212A will retrieve one of the affected bookings from booking data 224A. For illustration purposes, it is assumed that booking 1 is retrieved first, as shown by arrow 300. Booking module 212A then makes a first request to the seats module 217 to obtain seat assignments for passengers A, B, and C. Seats module provides the seat assignments to booking module 212A. The agent has the opportunity to accept or reject those assignments. If they are unacceptable, another request may be made to seats module 217 and the process is repeated.

Eventually, when acceptable seat assignments have been obtained, booking module 212A updates booking 1 to record the seat assignment information. The updated booking 1 302 is shown within booking data 224B as that data exists at time T2.

The updating of booking 1 occurs during an End-of-Transaction (EOT) process represented by arrow 304. This EOT process makes the updates persistent within booking data and adds messages to various office queues to record that the seat assignments have been made for this booking.

While the travel representative is obtaining seat assignments for booking 1, that travel representative is mindful that the seat being assigned to passenger C must be adjacent to at least one empty seat. That empty seat is intended to be assigned to passenger D at the time booking 2 is processed so that the seat assignment request for passengers C and D may be fulfilled. Therefore, in the current example, it is assumed that seat 29A shown assigned to passenger C in booking data 224B is next to at least one seat that has not yet been assigned.

According to a serial processing methodology, after booking 1 has been processed, the airline representative repeats the process for booking 2. That is, a copy of the booking 2 data is retrieved from booking data 224B as that data exists at approximately time T2. This is indicated by arrow 306. Booking module 212A makes an additional request to seats module 217 for seat assignments for the flight segment S1. The seat assignments are returned to booking module 212A, and the travel representative has the opportunity to accept or reject these assignments. If the seat assignments are acceptable to the agent, these updates are made persistent within booking data. This is represented by arrow 310, which stores the updates to booking data 224C as that data exists at time T3. This occurs during an EOT process of the type described above.

In one embodiment, RDCS 102 is a multiprocessing system that may be processing many tasks at once. As such, while booking module 212A is processing the seat assignment request described above, many other requests are likewise being submitted and processed by booking and seats modules. Many of these requests may be in process between the time the EOT occurs for booking 1 and the time booking 2 is processed. As a result, even though at least one unassigned seat had been available next to seat 29A at the time the EOT occurred for booking 1, this may no longer be the case when processing of booking 2 finally occurs. This is shown by entry 308 of booking data 224C at time T3, which indicates that the seat assignment request could not be fulfilled. When this type of situation occurs, the agent is forced to repeat one or more of the processing steps for bookings 1 and/or 2. For instance, the agent may recognize that a seat 32C is available next to seat 32D currently assigned to passenger D. Therefore, the agent may attempt to re-process booking 1 with the aim of assigning seat 32C to passenger C. Again, this may not be successful if this seat is assigned in the interim to another intervening request.

As may be appreciated by the above description, in prior art systems, there is no way to process requests that involve multiple bookings as though the bookings are a single booking. Instead, each booking is processed in turn in a serial fashion, sometimes resulting in unsatisfactory results and the need to process at least one of the bookings again. This wastes system and human resources.

In addition to the foregoing, the type of processing described above requires the aid of an airline representative to complete. There is no way to automate the serial processing of requests to obtain desired results.

While the current example focuses on obtaining seat assignments for multiple bookings, similar processing steps are needed to accommodate any type of request that involves multiple bookings. For instance, assume that bookings 1 and 2 have been created and stored within booking data at time T1. A first flight F1 had been selected to accommodate booking 1 for the first leg of the journey, and a different flight F2 had been selected to accommodate booking 2 for the same first leg of the journey. If the passengers of bookings 1 and 2 decide they want to travel on the same flight for this leg of the journey, the bookings will be accommodated in the serial fashion described above. That is, a first one of the bookings may be re-booked in attempt to place all passengers on the same flight. This may, or may not, produce satisfactory results that may require the other booking to be re-processed. There is no way to retrieve and process both bookings together to satisfy this flight request.

Still other examples may involve meal or other special requests. For instance, a passenger of one booking may submit a request for vegetarian meals for all parties in both bookings 1 and 2. Using booking module 212A, this request can only be processed by first processing one of the bookings, and then handling the other booking. This is time consuming, tedious, and error prone.

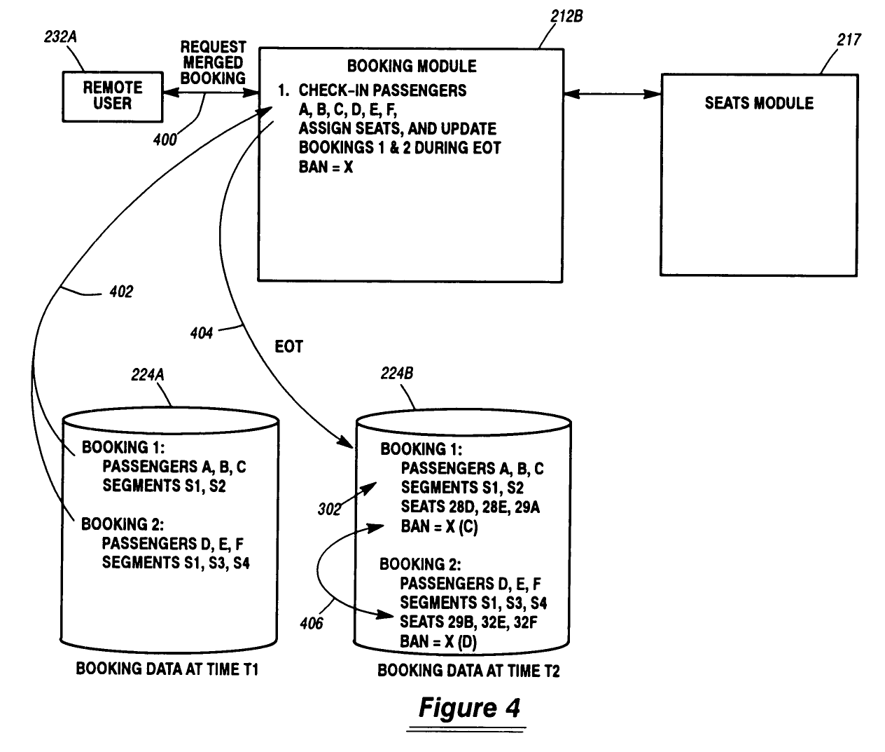

The limitations of the serial system and method are addressed by the current parallel mechanism for processing multiple bookings at once. This is described in regards to FIG. 4.

FIG. 4 is a block diagram that illustrates the processing of multiple bookings according to one embodiment of the current invention. This processing is performed by booking module 212B, which is adapted to process multiple bookings in parallel as though they were a single booking.

The scenario used to describe booking module 212B is the same as that discussed in regards to FIG. 3. That is, the two bookings described above have already been created by booking module 212B and stored within booking data 224A as that data exists at time T1. Passenger C of booking 1 desires to sit with a passenger D from booking 2. This request is made to an airline representative shown as remote user 232A. This representative makes a merged booking request for passengers C and D of bookings 1 and 2, respectively. This request is forwarded to booking module as represented by arrow 400.

In response to the merged booking request for passengers C and D, booking module 212B retrieves the bookings that are specified by the request, which in this case are bookings 1 and 2. This is represented by arrow 402. Booking module 212B merges the booking data together as though it is part of the same booking. Booking module 212B then makes a request to seats module 217 for seat assignments, taking into account that passengers C and D would like to sit with one another. Seats module 217 responds with seat assignments for all passengers in the bookings. These assignments may be accepted by the travel representative, or may instead be rejected such that another request is made to seat modules 217 for different assignments.

In one embodiment, the seating assignment request made by passengers C and D according to the current example can be satisfied only if these passengers have tickets within the same compartment of the craft (e.g., first class, business class, etc.) That is, passenger C may not request a seat next to D who is seated in the first class compartment unless passenger D also has a first-class ticket.

Although passengers C and D must be booked to the same compartment to satisfy the above-described request, they need not be in the same booking class. A booking class is a classification that matches a number of seats with pricing, promotions, marketing restrictions, and so on. For instance, ten seats in the coach compartment may be allocated to a booking class M as a promotion for those passengers that purchase their seats using a particular web-site. These seats may be sold at deep discounts. A different booking class Y may include more expensive seats not associated with any discount. Many such booking classes may be defined for a given compartment.

When a booking is created, all passengers recorded by that booking will be included within the same booking class. For example, all passengers of booking 1 will be placed in the same booking class. However, the passengers that are involved in a request to merge two or more bookings in the foregoing manner need not be in the same booking classes. That is, passengers in booking 1 need not be in the same booking class as passengers of booking 2 in order to fulfill the merge request.

In addition to being booked in different booking classes, the passengers that are associated with the merge request such as passengers C and D need not be the same type of passenger. For instance, passenger C may be considered a high-value customer that flies frequently, and is therefore entitled to special “perks”, whereas passenger D may be a first-time flier of the particular airline. As another example, information within OCDB 222 may categorize passenger C as a business traveler, whereas passenger D is categorized as a leisure traveler. Other types of attributes may distinguish the passengers of multiple bookings. This will be discussed further below.

During the processing of the multiple bookings in the foregoing manner, booking module 212B assigns at least one identifier to each of the bookings so that the bookings cross-reference one another. This type of an identifier may be referred to as a Booking Association Number (BAN). This BAN, shown as BAN X in FIG. 4, may be used to indicate that passengers C and D have been associated with one another.

In one embodiment, a BAN may be a Registration Party Index (RPI) of the type known in the art. Alternatively, the BAN is, or includes, one or more pointers that associate the bookings with one another. The BAN may also take the form of one or more confirmation numbers. For instance, a booking may store the confirmation numbers of all other bookings with which it is associated, and vice versa This is discussed further below.

Eventually, it is assumed that acceptable seat assignments are obtained from seats module 217. These updates are made persistent to booking data at time T2, 224D as represented by arrow 404. In one embodiment, this includes updating two records within a database, with the first record storing data for booking 1 including the new seat assignments for passengers A, B, and C. Also at this time, the record for booking 2 is updated with the seat assignments for passengers D, E, and F. These seat assignments allow passengers C and D to sit next to each other in seats 29A and 29B of the flight that accommodates segment S1.

The updating of records within database 204 occurs during an EOT process described above. This process may cause messages to be placed on office queues to indicate that seating has been completed for the two bookings. During the EOT process, each booking is updated to include the BAN, which in this case is “X”. In particular, booking 1 records that BAN X is associated with passenger C. Similarly, booking 2 records that BAN X is associated with passenger D. In this manner, bookings 1 and 2 are linked because of passengers C and D.

In the current example, BAN “X” associates just two passengers. However, that BAN may instead by used to associate more than two passengers. For instance, BAN X may further associate passengers E and F that wish to sit with passengers C and D.

In another scenario, additional passengers in the two bookings may wish to sit with one another, but not necessarily with passengers C and D. In this case, a different BAN may be assigned to associate those passengers. For instance, if passengers A and E make a request to sit with one another, a second BAN will be assigned to associate passengers A and E.

Although the above example describes the association of two bookings, it may be appreciated that the same process may be used to link more than two bookings. For instance, assume yet another booking contains passengers G, H, and J. Passengers E and G also wish to sit with passengers C and D. Therefore, the same BAN may be used to associate four passengers of three different bookings.

As another example, assume that passengers E and G wish to sit together but not necessarily with passengers C and D. In this scenario, a first BAN will be used to link passengers C and D of the first and second bookings, respectively. A second BAN is assigned to link passengers E and G of the second and third bookings, respectively. Any number of bookings may be associated in this, or a similar, manner.

As may be appreciated from the foregoing, a BAN may be used to associate multiple passengers of multiple bookings with one another. A BAN may also be used to associate multiple bookings with one another without reference to any given passenger. This may occur because of a request that involves all passengers in the bookings. For instance, assume bookings 1 and 2 were originally created using different flights for the first leg of the journey. A subsequent request submitted by one of the passengers of bookings 1 or 2 requests that these bookings be re-accommodated so that all passengers are traveling on the same flight for the first leg of their journey. In response, booking module 212B will retrieve both of the previously-created bookings 1 and 2. The bookings will be merged, and booking module 212B will make a request to space module 216 for space on a same flight for all six passengers. Booking module 212B will assign a BAN to associate bookings 1 and 2 without regard to any given passengers.

In response to this request from booking module, space module 216 will find an available flight with the necessary space and sell that space on behalf of all passengers. The space may be located on the same flight as had been used to accommodate the first leg of the journey for one of the bookings, or may be on a different flight entirely. The information for the space is returned to booking module 212B. If the newly-purchased space is acceptable, both bookings 1 and 2 are updated within booking data 224B during the EOT procedure to record new flight information and the assigned BAN. Sometime during this processing (e.g., either during the initial request to space module 216 or sometime thereafter), any space that is no longer needed, such as the space that had originally been booked for the passengers, will be released to space module.

The most recent example illustrates how bookings are processed in parallel to place passengers from those bookings on a same flight. This will occur without regard to specific seat assignments, which will be assigned later by seats module 217. This type of parallel processing may likewise be used to satisfy other types of requests. For instance, a passenger may submit a request for vegetarian meals for all passengers in two or more bookings. This request may be processed using a mechanism similar to that shown in FIG. 4. Booking module 212B retrieves all bookings, makes the request on behalf of all passengers for the service as though the passengers are part of the same booking, and updates the individual bookings within booking data 224 during a single EOT procedure.

The current illustrative scenario involves two bookings that were entirely unrelated at time T1. In one embodiment, each of these bookings may be stored as a respective database record within databases 204. According to the current example, at time T2, these bookings have been associated using the BAN “X” that links passengers C and D. As previously noted, this BAN may include other indicia such as pointers 326 to link the bookings. However, the associated bookings remain stored in separate data structures such as in respective records.

As may be appreciated, the system and method of FIG. 4 solves the limitations of the prior art system. The merged booking process allows the passengers of the associated bookings to be managed in parallel as though they are part of the same booking. Because the request is processed for all passengers at the same time, there is no opportunity for an intervening unrelated request to gain access to space, seat assignments, or other services that are needed to satisfy the request for the associated bookings. Thus, multiple processing iterations are not generally required, as is the case when processing multiple bookings in a serial manner.

The mechanism of FIG. 4 may be largely automated. That is, an airline representative need only indicate that the specified bookings are to be merged during request handling. The system automatically takes care of ensuring the request is fulfilled in a manner that generally does not require multiple iterations to obtain satisfactory results. Human intervention may, but need not, be used to verify returned results. This saves both system and human resources, and also saves passengers time and frustration.

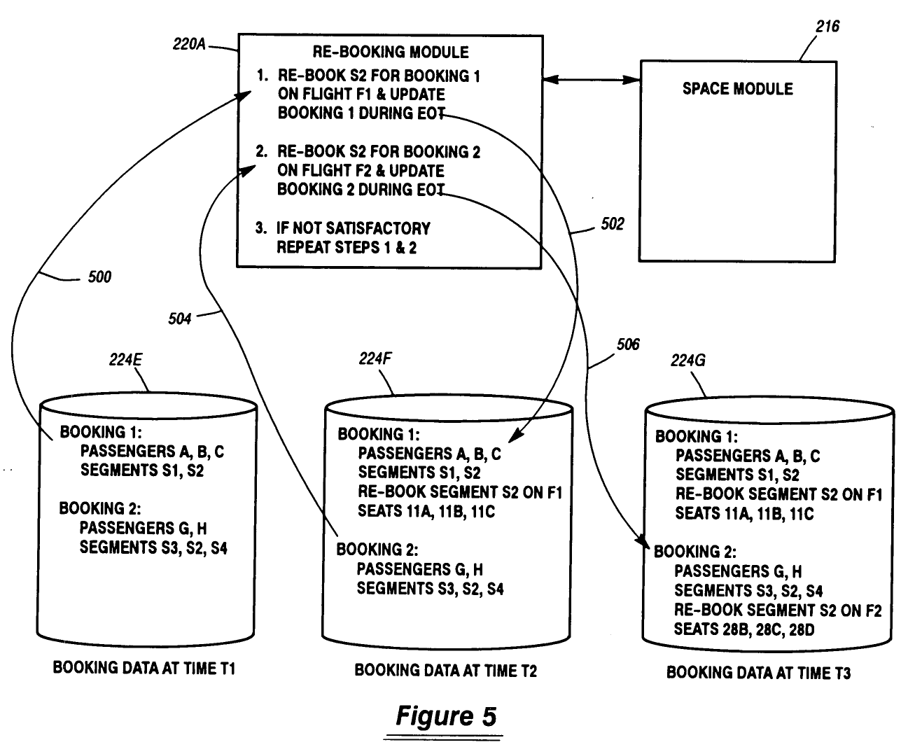

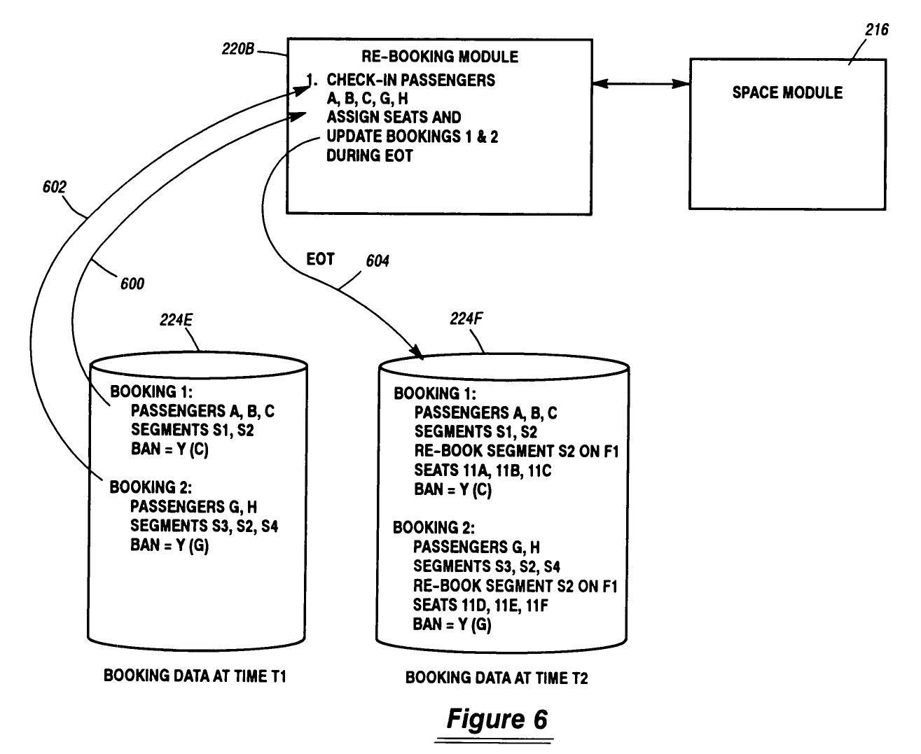

The above-described mechanism that allows multiple bookings to be handled as a single booking may be used to re-accommodate passengers after a travel event such as a flight cancellation or delay occurs. This is discussed further in regards to FIGS. 5 and 6.

B. Re-Accommodation Operations

FIG. 5 is a block diagram illustrating one serial method of re-booking passengers to an alternative flight after the occurrence of a travel event such as a flight cancellation or delay occurs. Assume for this example that passengers A, B, and C had been previously booked on a trip containing segments S1 and S2. The associated booking data, “booking 1”, is stored in booking data 224. Different passengers G and H are booked on a different trip containing segments S3, S2 and S4. The booking data for this trip is stored as “booking 2” within booking data 224. Segment S2 of both bookings 1 and 2 is being accommodated on the same flight. Additionally, passenger C from booking 1 is seated next to passenger G from booking 2 via a seat assignment request.

Next, assume that the flight for segment S2 is cancelled such that every booking assigned to that flight must be re-accommodated. According to prior art mechanisms, re-booking module 220A searches booking data 224E to locate the bookings assigned to the cancelled flight. For example, at time T1, booking 1 is located, and information for that booking is retrieved, as indicated by arrow 500. Re-booking module 220A makes a request to space module 216 for space to re-accommodate this booking on a different flight. The space returned by space module is recorded by an EOT process that updates booking 1 as indicated by arrow 502. The updated booking data is shown as booking data 224F at time T2.

Next, booking 2 may be located and relevant information is retrieved for that booking, as indicated by arrow 504. A request is made by re-booking module to space module for the necessary space. When a response is received, re-booking module 220A updates booking 2 with this information during a second EOT procedure, as indicated by arrow 506. The updated data for bookings 1 and 2 as it exists at time T3 is shown in booking data 224G.

As noted from booking data 224G, bookings 1 and 2 will not necessarily be booked on the same flight. Prior art re-booking modules have no way to automatically handle a request to place two bookings on a same flight, or to grant any special seating or other requests. As a result, after the automated re-booking process occurs, the passengers may have to approach an airline representative who will then utilize a manual process similar to that shown in FIG. 3 in attempt to provide better results. According to the prior art, this will involve the use of a booking module 212A and the serial booking procedure described above.

FIG. 6 is a block diagram of one mechanism of re-bookings passengers according to one embodiment of the current invention. In this scenario, it will be assumed that the same bookings 1 and 2 of FIG. 5 are involved in the re-accommodation process. It will also be assumed that these bookings have been processed by a booking module that operates in a manner that is similar to booking module 212B of FIG. 4. Therefore, these bookings have previously been associated with a BAN that associated either the entire bookings 1 and 2, or one or more passengers of these bookings. In the current example, this is shown as BAN “Y” in FIG. 6, which associates passengers C and G.

It will be assumed that re-booking module 220B first retrieves booking 1 for re-accommodation from booking data at time T1 as indicated by arrow 600. Re-booking module 220B is adapted to process bookings in a parallel manner according to the current invention. As such, when re-booking module determines that booking 1 has been assigned a BAN, rebooking module searches the booking data for all other bookings that are being re-accommodated and that have the same BAN. This search locates booking 2, and re-booking module 220B therefore retrieves this booking data. More bookings may have this same BAN in another scenario. Alternatively or additionally, a booking may have multiple BANs, requiring one or more additional searches. For instance, booking 2 may not only reference BAN Y, but may also store a BAN Z that links it with a third booking. When this third booking is retrieved, it may store yet a different BAN requiring one or more other bookings to be retrieved, and so on. Thus, multiple searches may be needed to locate all bookings that are directly or indirectly related to one another.

In one embodiment, after all bookings that are directly or indirectly associated with booking 1 have been retrieved, re-booking module 220B automatically re-accommodates all passengers of these associated bookings as though they are part of the same booking. That is, re-booking module makes a request to space module 216 for enough space to re-accommodate all of the passengers in all of the associated bookings. In one embodiment, this occurs in a manner that satisfies all special service requests (e.g., wheel chair, bassinet, etc.), and that maintains the passengers in the booking class in which they were originally booked. This is described further below.

After adequate space has been obtained, re-booking module 220B makes a request to seats module 217 for seat assignments for all associated passengers. In one embodiment, this request may attempt to satisfy special seating assignment requirements for associated passengers such as passengers C and G of the current example. In another embodiment, no seat assignment requests are taken into account for re-accommodation purposes because of the difficulty is finding alternative transportation for all passengers on a cancelled flight. Thus, in this latter embodiment, if C and G had been associated with one another via a BAN, C and G will be on the same re-accommodation flight, but may not necessarily sit together.

In either embodiment described above, the new flight and seat assignment information for all passengers in all associated bookings are stored to booking data 226E at time T2 during an EOT process represented by arrow 602. This process updates each associated booking that was involved in the re-accommodation.

The process of FIG. 6 can be accomplished in an entirely automated manner. That is, the BAN that had previously been associated with the bookings allows the system to automatically recognize that bookings are associated and should be re-accommodated together. Thus, there is no need to involve an agent during this processing. Moreover, because the purchasing of space and special services occurs at the same time for all passengers of the multiple associated bookings, there is generally no need for performing multiple processing iterations to obtain satisfactory results. This saves both human and system resources.

The above description sets forth the types of processing that occurs during booking and re-booking procedures according to the current invention. These capabilities are supported by a new architecture within database systems 204.

Prior art RDCSs utilize databases that are arranged as flat files. Those files contain records that are searchable using a single primary key value, which is generally the confirmation number that is assigned to each booking when the booking is created. When booking or re-accommodation operations are initiated, a search is conducted on the flat file using the primary key value. A single record having that primary key is retrieved for processing and is eventually updated during a booking or re-booking transaction. This results in a system that processes exactly one booking at a time.

The current invention is supported by database 204 that is organized as one or more relational tables. These tables can be searched using many different index attributes, including confirmation numbers, passenger names, a location and/or date of departure, customer numbers, and so on. This makes it much easier to retrieve the necessary information required to merge multiple bookings according to the above-described process. This is described further below in reference to the remaining drawings.

The current invention is also supported by an improved user interface that may be implemented via user interface modules 201 and/or 234 (FIG. 2). This user interface allows a travel agent or airline representative to retrieve information for multiple bookings. This information may then be displayed on an output device such as a display screen as though the information is part of the same booking. The agent may initiate operations on behalf of the displayed passengers as a group during the same transaction and then commit the changes during a single EOT process. This user interface is described in detail below.

C. One Embodiment of a User Interface According to the Invention

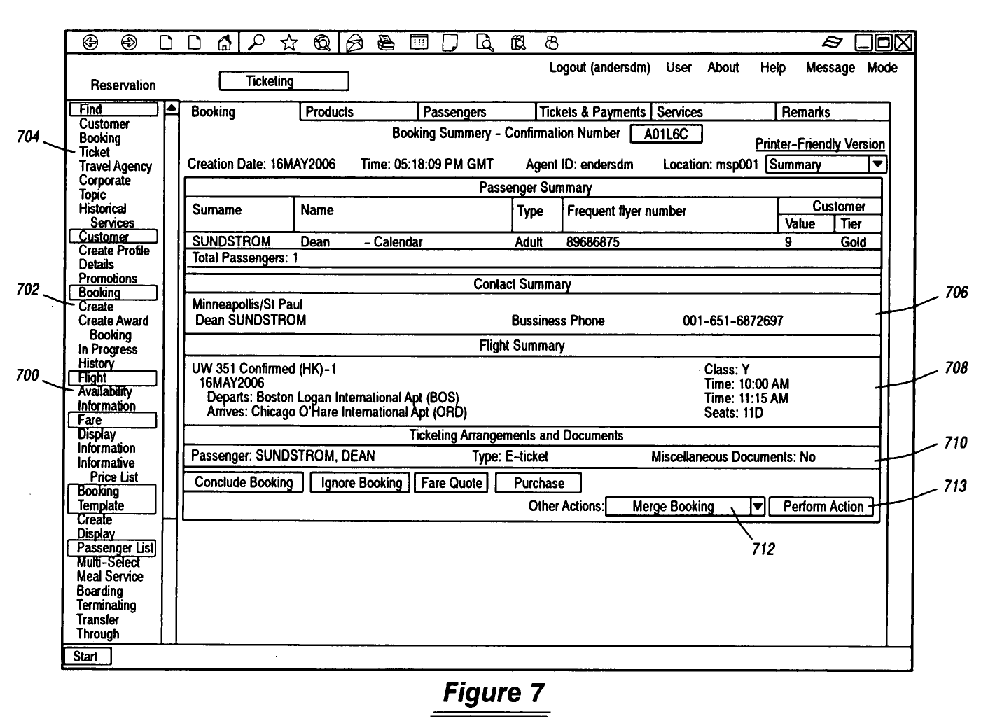

FIG. 7 is a screen display that, depending on the embodiment, is provided by one or both of user interface modules 234 and 201 (FIG. 2). This display is used to view information for a previously-created booking. This screen is obtained by selecting the “Ticket” function 704, as may be done using an input device such as a mouse, a keyboard, a touch screen, or any other device known in the art. In the current example, the booking being viewed relates to a trip being taken by passenger Dean Sundstrom. The booking is associated with confirmation number A01L6C, as appears at the top of the screen.

Before the booking can be displayed as shown in FIG. 7, this booking must first be created. For background purposes, this occurs as follows. A travel agent or a representative of the airline may first display several flight options that are available to accommodate the travel plans of one or more passengers. This list of options may be obtained by selecting the “Flight Availability” function 700 and entering desired departure times, dates, and locations, and so on. This allows the agent to select one or more flights on which the passenger(s) wish to travel.

Next, the agent selects the “Create Booking” Function 702 which will generate a screen for entering the information for the selected flight(s) that were identified using the “Flight Availability” function. After entering passenger information, including name, frequent flier number, ticket type (e.g., “adult”), any necessary contact information, special request information, and any other pertinent information relating to the trip, the agent uses an appropriate function to save this booking. This creates a corresponding record within databases 204 for the passengers traveling together on this trip. This booking is assigned a unique confirmation number by the system.

As described above, once the booking has been created, the agent may then view the booking by selecting the “Ticket” function 704 to obtain the screen display of FIG. 7. This screen includes the confirmation number for the booking, the names of the one or more passengers included in the booking (e.g., Dean Sundstrom), and the number of passengers for this booking (“one”). Passenger contact information is provided in screen area 706, and flight summary information is listed in screen area 708. Ticketing information is available in screen area 710.

Next, assume that a second booking has been created sometime in the past for another passenger, Professor Dustin Anderson. Dustin is traveling round trip from Boston to Chicago, and is booked on the same flight from Boston to Chicago on which Dean is traveling.

After Dean has booked his flight, he mentions to the agent that his colleague Dustin is traveling on the same flight and both Dustin and Dean would like to order special means (e.g., vegetarian meals.) To satisfy this request, the agent uses the drop down menu associated with input area 712 to select the “Merge Booking” function 712. The agent then activates the “Perform Action” button 713 to initiate the Merge Booking function.

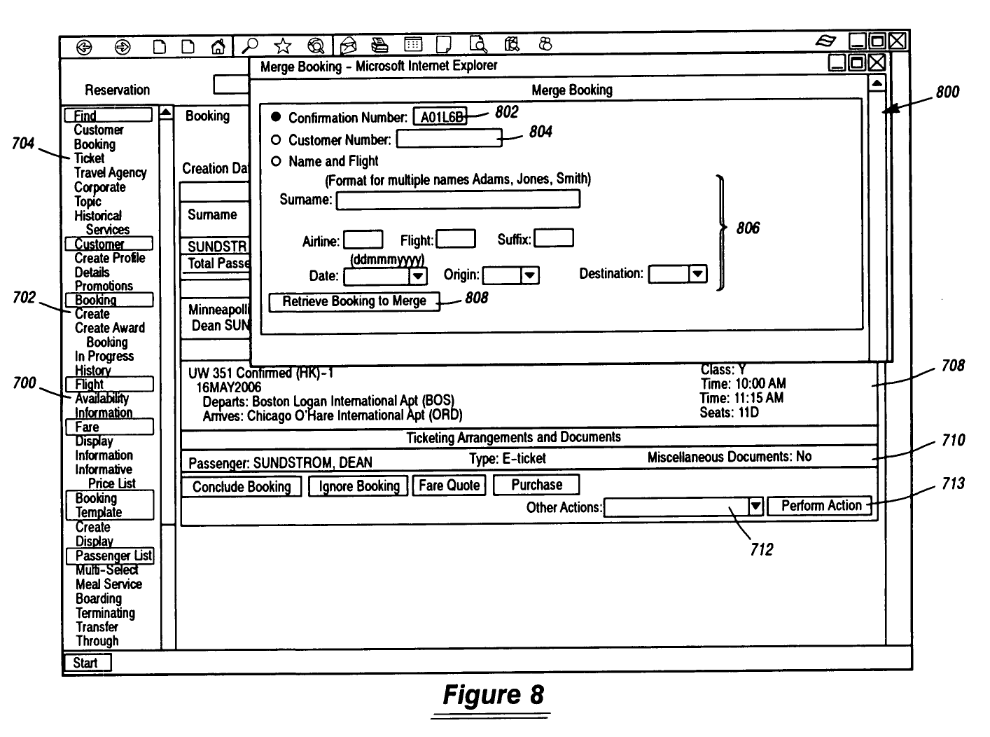

FIG. 8 is a screen display that is provided after an agent selects the “Merge Booking” function 712 according to the current example. This results in the display of a “Merge Booking” window 800 that is overlaid on the original ticketing window of FIG. 7. This window provides input areas to allow the agent to identify an additional booking to merge with the original booking for Dean Sundstrom. The additional booking may be identified in one of several ways. According to the example shown in FIG. 8, a confirmation number for Dustin Anderson's booking may be entered into input area 802. This may be accomplished if Dean Sundstrom has obtained this number from his colleague.

If the confirmation number is not available, a customer number may instead be entered into input area 804. This customer number may be a frequent flier number, for instance, or some other number assigned by the airlines. Yet another option allows the agent to enter name and flight information using input areas 806. After one of the three options has been employed to identify the additional booking, the “Retrieve Booking to Merge” selector 808 is activated to retrieve the additional booking. This results in this additional booking being retrieved from booking data 224 (FIG. 2).

As noted above, databases 204, including booking data 224, is stored within one or more relational tables that may be searched on as many different fields as has been predetermined by the database designers. That is, the search index is not limited to a confirmation number as was the case in the past when flat files, rather than relational tables, were used to store booking information. This facilitates the use of the merged booking process, since often times the confirmation number of one booking is not known by passengers of another booking that are seeking to use the merged booking function. Thus, according to the current embodiment, a passenger that wants to merge two or more bookings is able to initiate this processing by providing any searchable information that identifies a passenger or a booking.

In the exemplary embodiment of FIG. 8, the characteristics that may be provided for retrieving a booking include the confirmation number, customer number, or a surname and flight. It will be appreciated, however, that many other options may be used in the alternative. For instance, in one embodiment, the passenger's home address or phone number may be used to retrieve this data. Because the databases 204 are relationship tables that are arranged such that any field may be made searchable, virtually any passenger data may be employed to initiate the search for another booking that is to be used during the merge process.

In the current embodiment, the information provided to retrieve a booking need not uniquely identify the booking. For instance, assume that providing a flight number and surname results in the retrieval of two different bookings. When this occurs, a window will overlay the screens of FIG. 8. This window will include information for each of the retrieved bookings. Using this information, the agent will select the booking that is intended to be included in the merge process. In one embodiment, a booking is selected by activating (i.e., “clicking on”) an associated hyperlink for the booking.

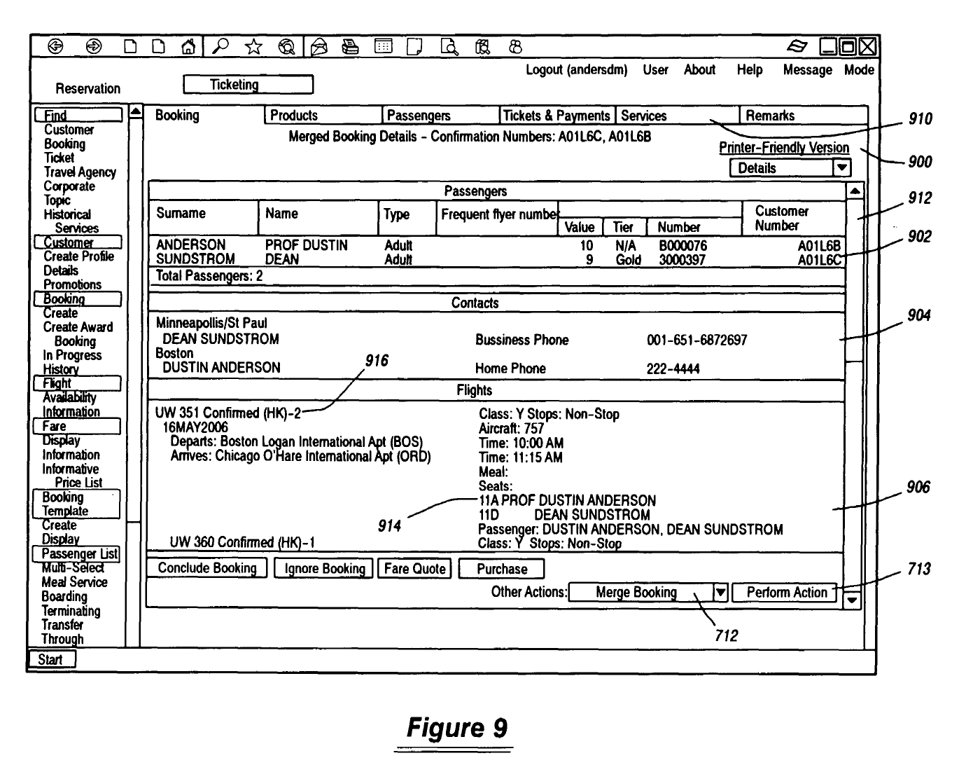

In any event, after one or more identified bookings have been retrieved and a desired booking has been selected, if necessary, a display screen is provided that displays in a consolidated manner all information for all passengers of the original booking (e.g., the booking for Dean), as well as all passengers for the newly-retrieved, and if necessary, selected booking (in this case, the booking for Dustin). This consolidated display screen is said to “visually merge” the data for the multiple bookings, as is described in reference to FIG. 9.

FIG. 9 is a display screen provided after information for two bookings has been retrieved and this information has been visually merged according to the above-described process. Screen area 900 provides the confirmation numbers identifying the two bookings. Screen area 902 lists all passenger names for all bookings (in this case, Dustin and Dean). If any of the bookings had included more than one passenger, more than two names would be listed in this screen area. This area also provides the type of ticket (e.g., “adult”), and additional information such as a customer tier and number, as well as the confirmation numbers.

Screen area 904 provides contact information for the passengers included in the merged bookings. Screen area 906 includes the information about the booking flight, including the departure time, date, and location, and information pertaining to seat assignments for all passengers.

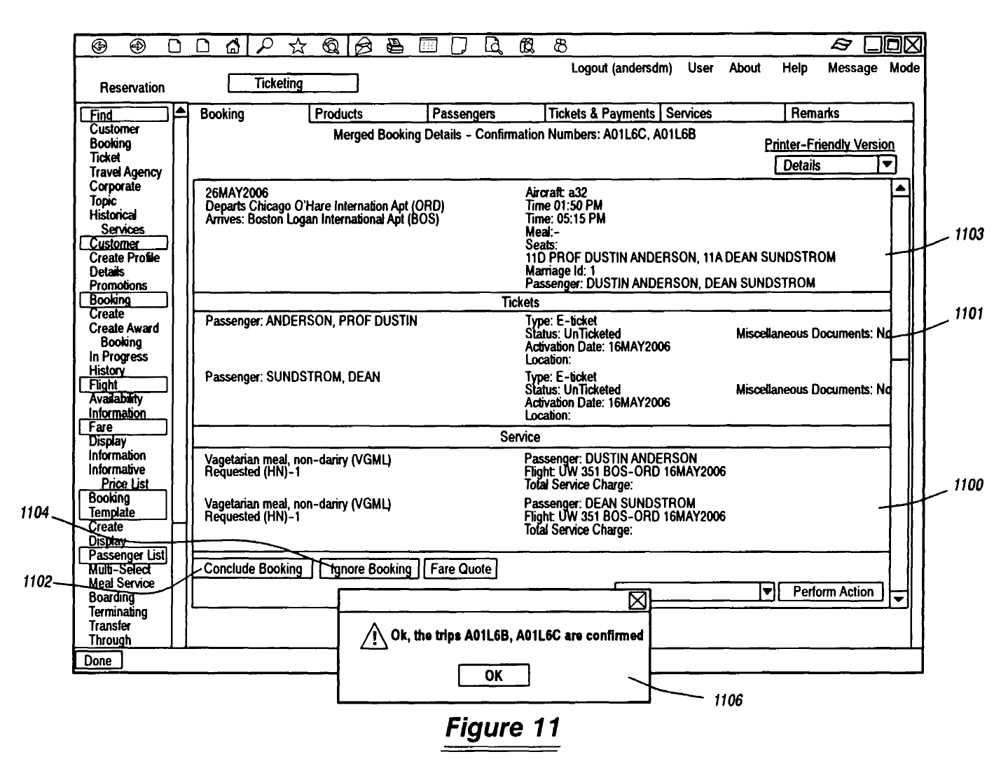

It will be appreciated that the screen display related to FIG. 9 contains additional screen areas that may be viewed by using the scroll bar 912 or another scrolling mechanism. This allows a user to scroll to the bottom of the screen, as will be described in reference to FIG. 11 below.

Merging data for multiple bookings into a single consolidated display screen as shown in FIG. 9 makes it much easier for an airline agent or another representative to determine, at a glance, what services and passengers are currently listed in those bookings. Likewise, any processing for the bookings may be initiated from a single display screen. In prior art systems, the only way to view data for multiple bookings is to toggle between two or more display screens, each being associated with a respective booking. This is cumbersome, and may require a user to remember data he or she toggles from screen-to-screen.

Although this example of FIG. 8 illustrates the visual merging of two bookings, many bookings may be merged using the process illustrated in FIG. 8. This is accomplished by re-selecting the “Merge Booking” function in input area 712, activating the “Perform Action” button 713, and repeating the above-described process for each booking that is to be added to the merged booking.

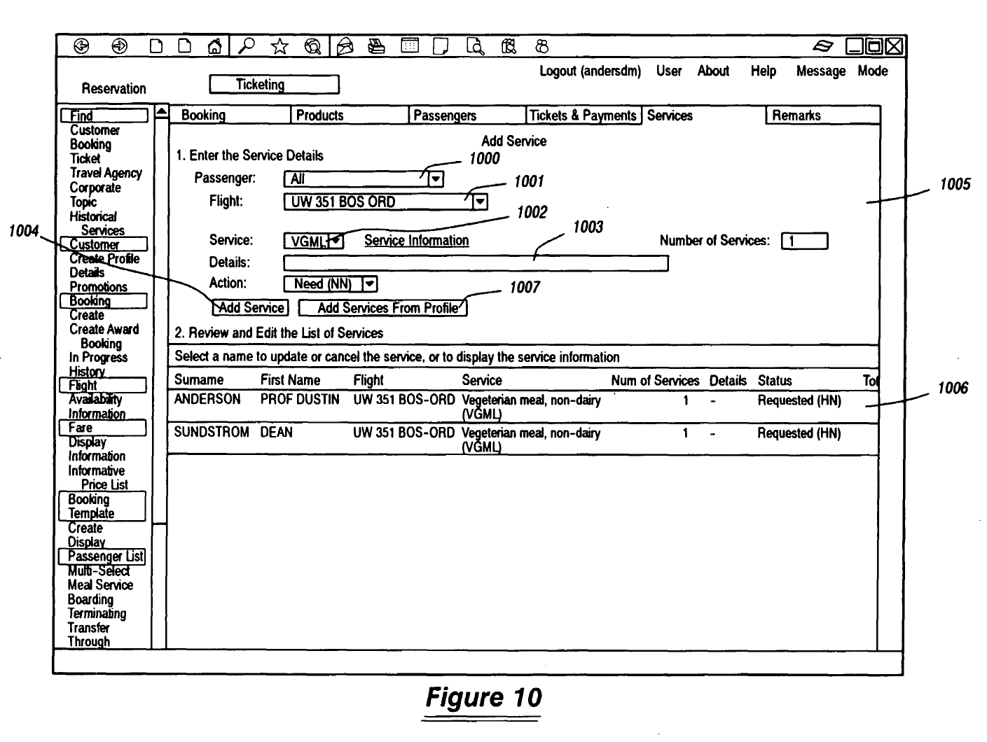

After all of the desired bookings have been visually merged into a display such as that shown in FIG. 9 using the “Merge Booking” function, an operation may be performed on these bookings as though these bookings comprised a single booking. As noted above, this operation may involve reserving some type of service for one or more passengers of the merged booking. To initiate this, the “Services” tab 910 at the top of the screen is selected, as is described further in regards to FIG. 10.

FIG. 10 is a screen display that is provided to allow an agent to reserve services for some or all of the passengers of a merged booking. As noted above, this screen is obtained by selecting the “Services” tab 910 of FIG. 9. The service to be provided for some or all passengers of the merged bookings is selected using the drop-down menu 1002. According to the current example, the selected service is vegetarian meals (“VGML”).

In one embodiment, service profiles may be created that include one or more services that may be associated with certain flight segments, certain ticket or passenger types, predetermined dates and/or days of the week, and so on. Such profiles may be selected using the “Add Services from Profile” button 1007, which will cause a list of the available profiles to be displayed in a window overlaid on that of FIG. 10. The agent may select the profile, which will make the additional services available when drop down menu 1002 is activated during service selection.

In addition to selection of the service, the agent also selects the passengers for which this service is to be provided. This is accomplished using drop down menu 1000. In this example, the meals are being requested for “All” passengers involved in the merge processing. If desired, the agent may instead select a subset of all of the passengers using the drop down menu.

Next, using window 1001, the agent selects the flight that is associated with the service that is being requested. This is necessary since the merged booking may be associated with multiple flights. For instance, according to a scenario other than that of the current example, the passengers of the multiple bookings may be traveling together on two or more flight segments, and may desire vegetarian meals on only one such segment.

Finally, the agent may enter additional details regarding the service in text entry area 1003.

After the passenger(s), flight, and service are selected, and any details are provided, the agent activates the “Add Service” function 1004. This causes the service to be reserved for the selected passengers on the selected flights. This is shown in screen area 1006, which indicates that vegetarian meals have been reserved for both Dean and Dustin.

FIG. 11 is a screen display that is provided after the “Booking” tab of FIG. 10 has been re-selected following reservation of the service for the bookings that have been merged. This display is similar to that of FIG. 9, and illustrates additional screen areas that are obtained by using scroll bar 912 to scroll to the bottom of the screen of FIG. 9. Of particular interest is the “Service” screen area 1100, which now shows the reservation of the vegetarian meals for the passengers of the merged booking. Information pertaining to the tickets and the flights are shown in screen areas 1101 and 1103, respectively.

The reservation of this service can be made persistent by selecting the “Conclude Booking” function 1102. Selection of this function causes the information to be stored to databases 204 during an EOT process. In one embodiment, a respective record is updated within booking data 224 for each of the bookings that was involved in the merge process. In the current example, a first record is updated for Dustin's booking, and another record is updated for Dean's booking.

After this EOT process has completed, display window 1106 is provided indicating that the reservation of the services for all bookings included in the merge process has been confirmed. The confirmation numbers of each of the bookings are included in this message.

During the EOT process, the bookings that were involved in the merged booking process are cross-referenced to, or associated with, one another. As described above, this may be accomplished by assigning a common identifier such as a Booking Association Number (BAN) to all such bookings, or to specific passengers within these bookings. The assigned BAN is then stored with the other booking data in a corresponding booking record when the changes are made persistent to the booking data.

In one embodiment, cross-referencing of the booking records may alternatively or additionally be accomplished using confirmation numbers. For instance, a first booking may be updated to include the confirmation number(s) of the other bookings to which it is associated, and vice versa. Alternatively or additionally, pointers may be stored that point to the other records for the cross-referenced bookings. Any number of other mechanisms may be used to cross-reference the merged bookings.

Instead of using the “Conclude Booking” function 1102 to make the changes persistent in the foregoing manner, all of those changed may be “rolled back”, or discarded. This is accomplished by selecting the “Ignore Booking” 1104 function. This will cause the services that had been reserved during the merged booking process to be released for use by other passengers and no updates will be made to the bookings within booking data 224. In this case, no BANs or other cross-referencing mechanisms are used to associate the bookings.

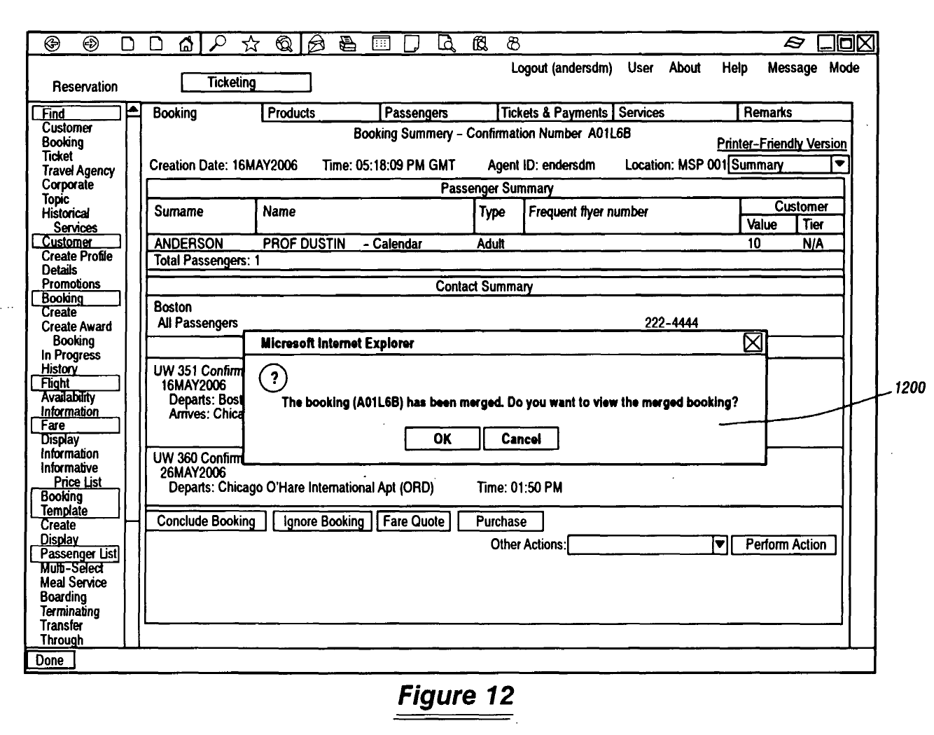

FIG. 12 is a screen display that is provided whenever a user retrieves a booking that has previously been merged with another booking using the above-described process. This display is similar to that shown in FIG. 9, and includes passenger data and information concerning booked flights. When this information is first retrieved, a pop-up window 1200 is provided to indicate that this booking has been merged. This window gives the user the option to view just the information for the single booking, as may have been identified via confirmation number, passenger name, or passenger number. Alternatively, the user may choose “OK” to view information for all passengers of not only the current booking, but all of the bookings to which that current booking was previously merged. If this alternative were selected in the current example, the display would also retrieve and display information for Dean Sundstrom.

The above illustration involves processing two different passengers that are on a common flight segment. This need not be the case, however. For instance, four bookings may exist for Dean Sundstrom, each related to a different up-coming trip. As may be appreciated, these bookings will each involve different dates, and may involve different flights and flight segments. Dean may wish to reserve vegetarian meals and/or some other service for some or all of these upcoming trips. Rather than process each booking individually, the agent may merge two or more of these bookings using the above-described process and reserve the requested service(s) for all trips at the same time. This saves human and system resources.

The above example illustrates reserving a service such as a vegetarian meal for one or more passengers of multiple bookings that have been merged in the foregoing manner. Multiple bookings may be merged for other purposes. For example, multiple bookings may be merged so that the same comment may be added to those bookings. To illustrate, a comment may be made to multiple bookings to alert crew members to the fact that one or more passengers associated with the bookings are allergic to a certain type of food. Any other remark may be added in the alternative. As another example, multiple bookings may be merged so that contact information for those bookings may be added using a single data entry step. This eliminates the need to update each booking individually. In yet another scenario, multiple bookings may be merged so that a ticketing arrangement may be associated with those bookings. As an example, assume multiple bookings are made for passengers that are part of the same tour group. These passengers will all be picking up their tickets at the airport. This information may be added to all bookings at once by merging the bookings, and then updating the ticketing arrangement information.

The merge process may also be used to allow passengers of multiple bookings to sit next to one another. For instance, assume that the two passengers of the current example had not originally been seated together. A request may be made by one of the passengers to obtain adjacent seats. To accommodate this request, an agent uses the screen displayed in FIG. 8 to visually merge the bookings. This will create the screen of FIG. 9.

The screen of FIG. 9 includes a “Flights” screen area that provides seat information. This seat information contains a hyperlink for each potential seat assignment. For instance, the seat assignment of “11A” for Dustin Anderson is associated with hyperlink 914 of FIG. 9. Assume for discussion purposes that Dustin is currently assigned to seat 28A which is not located next to Dean. Therefore, the agent will select the hyperlink for Dustin's seat, which will open a window to allow the existing seat assignment to be cancelled. This process may then be repeated using a similar hyperlink associated with the seat assignment for Dean.

After both Dustin's and Dean's seat assignments have been cancelled, the screen of FIG. 9 will include a “Select Seats” hyperlink for each passenger rather than a hyperlink associated with a seat number. The agent may select either of these hyperlinks. This will open a window that provides an option to assign seats for all passengers of the merged bookings for which seats have not yet been assigned. If the agent selects this option, a call is made to seats module 217 (FIG. 2) which will make a single seating request for both Dean and Dustin, since both passengers are no longer associated with seat assignments. This request will attempt to seat these passengers next to one another. The resulting seat assignments will be displayed for the agent in a screen such as shown in FIG. 9.

A similar type of operation may be performed to book a same flight for passengers of multiple bookings. For instance, assume that Dean and Dustin were not originally booked on the same flights, but decided they want to travel together on the same flight from Boston to Chicago. To accomplish this, an agent would merge the bookings to obtain a screen as shown in FIG. 9. In this case, however, the “Flights” section 906 lists different flights from Boston to Chicago for Dean and Dustin. Each of these flights will be associated with a hyperlink similar to the flights hyperlink 916 of FIG. 9.

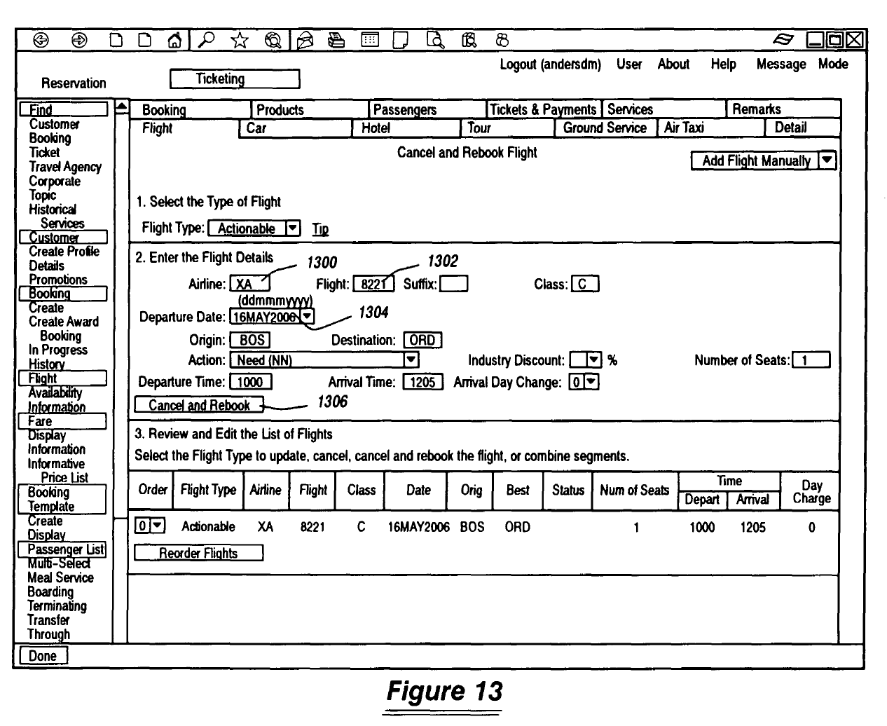

As was the case in the scenario discussed above, an agent may select the hyperlink for either passenger, which will open a window providing an option to cancel the flight. Assuming the hyperlink for Dustin's flight was selected, a screen similar to that shown in FIG. 13 will then be provided to allow the agent to make a request to book Dustin on a different specified flight, if desired. For example, the agent may specify the number of the flight on which Dean is booked. The agent then submits the request, which is forwarded to space module 216 for processing. If space is available, space module 216 will return new flight information for Dustin, which will be displayed on a screen similar to that shown in FIG. 9.

FIG. 13 is a screen display provided to book a passenger on a specific flight after a previous flight has been cancelled for that passenger according to the above-described example. This screen display will initially provide the information for the flight that is being cancelled. The agent may use the “Airline”, “Flight”, and “Departure Date” input areas 1300, 1302, and 1304 respectively, to enter a new flight. The “Cancel and Rebook” function 1306 is then selected to cause this request to be submitted to space module 216 in the above-described manner. This will return a display similar to that shown in FIG. 9. Seat assignments may then be made using the above-described method. When all processing is completed, the “Conclude Booking” function 1102 may be selected to make these updates persistent.

The foregoing describes how a flight is re-booked for one passenger so that he or she may travel together with one or more passengers of one or more other bookings. This type of operation may also be accomplished using a slightly different approach. According to this other approach, the hyperlinks associated with Dustin's and Dean's flights may be used to cancel both flights. Both flights are then listed as “actionable”, meaning they remain to be assigned. By selecting a hyperlink associated with one of these actionable flights, a window is opened allowing an agent to book both Dean and Dustin on the same flight. This request is submitted to space module 216, which will book space for both Dean and Dustin at the same time on the same flight. When results are returned from the space module, a screen similar to that shown in FIG. 9 will reflect the new flight assignments on the same flight. Seat assignments may then be made using the above-described method.

As described above, after flight and/or seat assignments have been made according to the above described mechanism, the “Conclude Booking” function 1102 may be used to make the assignments persistent and to record the BANs. If the results are to be discarded, the “Ignore Booking” function 1104 is selected instead.

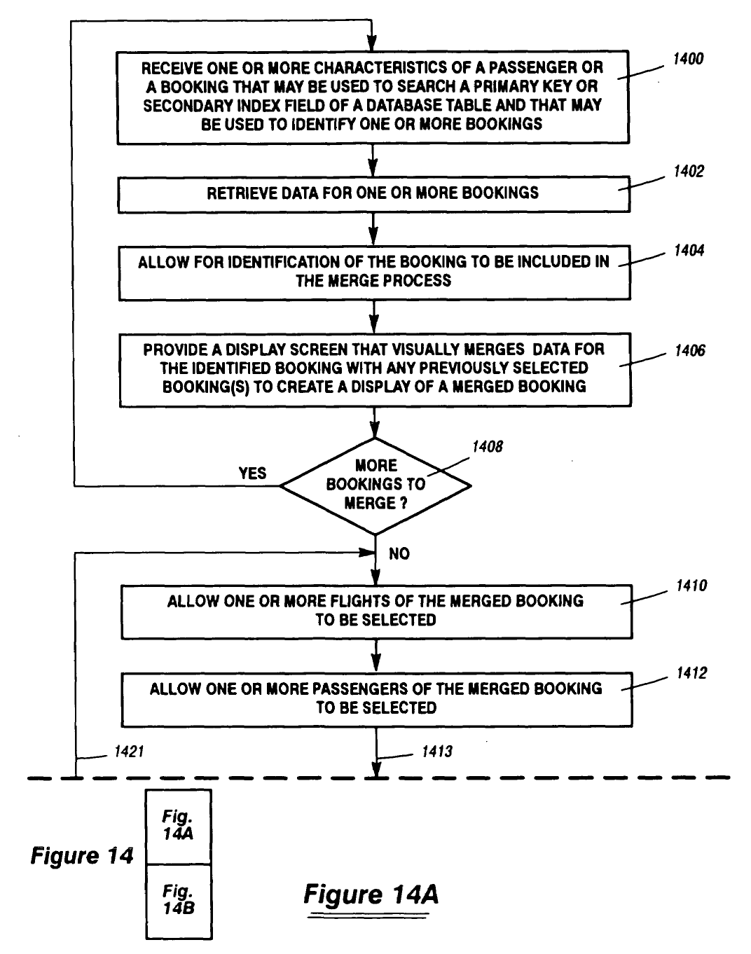

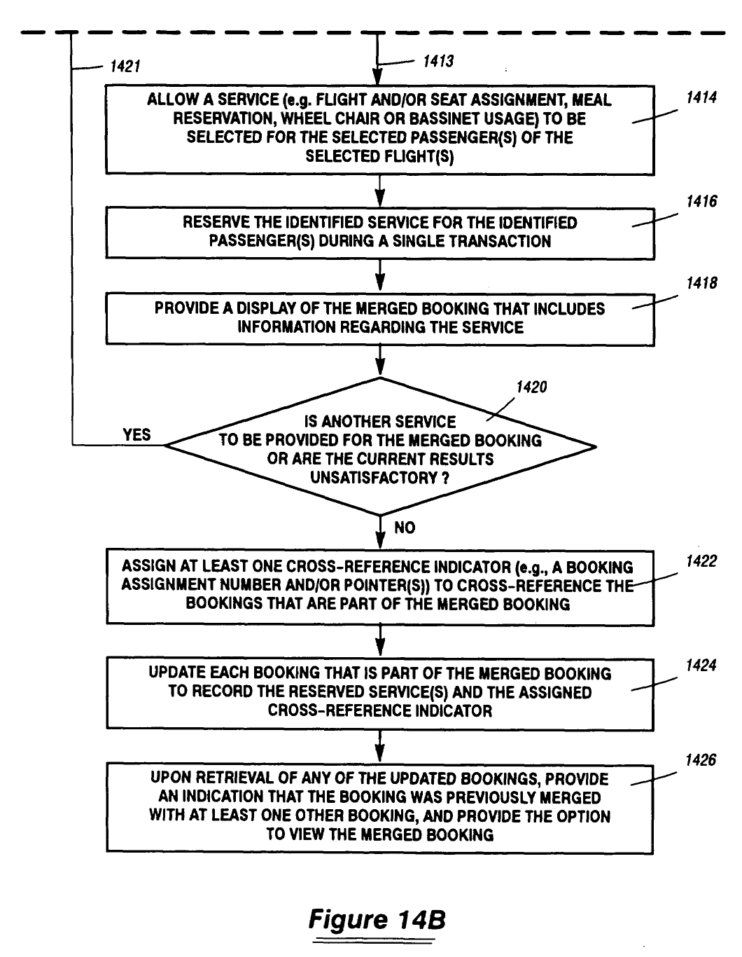

FIGS. 14A and 14B, when arranged as shown in FIG. 14, are a flow diagram of one computer-implemented method according to the current invention. The system receives one or more characteristics associated with a passenger or a booking that is used to identify a booking (1400). In one embodiment, the received characteristic may be data stored in a primary key field or one or more secondary index fields of one or more relational database tables. In the illustration described above, such indicia may include the confirmation number, a name and flight number, or a customer number. In other embodiments, other types of information may be used instead. Preferably, all such information is included in one or more field(s) of database table(s) defined to be searchable to avoid the necessity of performing a brute-force search.

After a booking is identified, the identification data (e.g., primary key or secondary index) is used to retrieve a booking from a database (1402). It will be appreciated that if the identification data does not uniquely identify a booking, as may occur if passengers with the same name are included in different bookings for the same flight, all bookings that match the identification data will be retrieved. These bookings will be displayed and the user will be provided with the opportunity to select the desired booking for inclusion in the merge process (1404).

Next, a display screen is provided that visually merges data for the most-recently identified booking with any previously-selected booking(s) to create a consolidated display of all of the information for all of the bookings, as shown in FIG. 9 described above. This merged information may be collectively referred to as the “merged booking” (1406). The display of the merged booking will include information for all passengers in all of the selected bookings in a manner that is similar to a display that would be created if all of the passengers of the selected bookings were included in the same booking. In one embodiment, each of the confirmation numbers will be provided in the display to identify the individual bookings that have been included in the merge process.

If more bookings are to be merged (1408), processing returns to step 1400. Otherwise, execution proceeds to step 1410, where the user is provided with an opportunity to select one or more transportation routes (e.g., flights) of the merged booking. In addition, one or more passengers of the merged booking may also be selected (1412).

Processing next continues to step 1414 of FIG. 14B as indicated by arrow 1413. There, the user is allowed to select a service to be provided to the identified passengers on the identified flights. Such a service may be the booking of the passengers to a same flight, the assigning of the passengers to adjoining seats, the reservation of a particular meal, the reservation of a wheelchair, a bassinet, a headset, the entering of comments, contact, or ticketing arrangement information, or may be any other type of service offered by the carrier.

After all of the selections are made for the merged booking, the request is processed as though all identified bookings are part of the same booking (1416). This processing reserves the requested service for the passengers on the selected routes (e.g., flights) during a single transaction. A display of the merged booking is then provided that includes information regarding the newly-booked service (1418). If another service is to be reserved for the merged bookings, or if the newly-reserved service is not satisfactory (1420), the process may be repeated by returning to step 1410 of FIG. 14A, as indicated by arrow 1421.

In one embodiment, if the current results are satisfactory and no other service is required, at least one cross-reference indicator such as a BAN or a pointer is assigned so that the individual bookings that were included as part of the visual merge processing are cross-referenced (1422). This may further involve cross-referencing passengers of multiple bookings by associating the cross-reference indicators with those passengers, as may occur when those passengers are to be seated with one another. This may instead involve cross-referencing entire bookings, as may occur if all passengers of one booking are to be on the same flight as all passengers of another booking.

Finally, each individual booking that was part of the merge process is updated to record the reserved services(s) and the assigned cross-reference indicator(s) (1424). In one embodiment, this involves updating multiple records of a database and further involves associating those records with one another using BANs that may include pointers, as discussed above. After these updates are made to booking data 224, any subsequent processing performed for any of these bookings will cause an informational notice to be displayed for the user. This notice indicates that the booking was merged with at least one other booking, and provides the option for the user to display all associated bookings in a visually merged manner (1426). Alternatively, the user may choose to view just the information for the specified booking.

The above-described system and method provides a mechanism whereby passengers of multiple bookings may be readily processed together as though they are part of the same booking. This saves time, and also saves system resources. Moreover, this mechanism generally provides satisfactory results without the need for multiple processing repetitions.

The user interface described herein may be employed anytime after multiple bookings have been created. For instance, it may be used to change or update the original booking accommodations. It may be used by a booking agent following any event that requires re-accommodation (e.g., flight delay or cancellation) wherein passengers are seeking the aid of a booking agent to locate alternative transportation options.

It may be noted that the flow diagram of FIG. 14 is merely exemplary. Many of the steps in these processes are optional. Moreover, many of these steps may be re-ordered without affecting the functionality of the system and method. Similarly, the system block diagrams described above are also exemplary only, and many other types of system architectures such as alternative RDCS systems may be employed in the alternative without departing from the scope of the current invention.

Therefore, while various embodiments of the present invention have been described above, they have been presented by way of example only, and not as a limitation. Thus, the breadth and scope of the present invention should not be limited by any of the above-described exemplary embodiments, but should be defined only in accordance with the following Claims and their equivalents

1. A computer-implemented method having instructions executed within a programmable processing system implementing a set of operations for managing passengers of a transportation carrier, comprising:
providing a user interface to allow a user to identify multiple bookings;
merging data for the multiple bookings on a display screen;
allowing the user to select an operation to be performed on the multiple bookings; and
simultaneously performing the operation on the multiple bookings as though the multiple bookings were a single booking.

2. The computer-implemented method of claim 1, wherein the operation is performed during a single transaction.

3. The method of claim 1, and further including providing a display screen providing information on results of the operation performed on the multiple bookings.

4. The computer-implemented method of claim 1, and further including at least one of:
allowing the user to select one or more passengers of the bookings; and
allowing a user to select one or more transportation routes for which to perform the operation.

5. The computer-implemented method of claim 4, and further including allowing a user to select a service to provide to the one or more passengers on the one or more transportation routes.

6. The computer-implemented method of claim 1, wherein the user interface allows the bookings to be identified using any one or more of a predetermined set of characteristics associated with the bookings and the passengers of the bookings.

7. The computer-implemented method of claim 6 wherein the one or more of the predetermined set of characteristics are each used to search one or more relational database tables.

8. The computer-implemented method of claim 1, and further including providing a notification when any operation is initiated on any one of the multiple bookings, the notification to indicate that the one of the multiple bookings was previously merged with the other ones of the multiple bookings.

9. The computer-implemented method of claim 1, wherein the operation is selected from a group consisting of:
placing passengers of the multiple bookings on the same transportation route;
assigning seats to allow one or more passengers of the multiple bookings to sit together;
requesting a special meal for one or more passengers of the multiple bookings;
simultaneously reserving use of a service for one or more passengers of the multiple bookings;
adding a comment to the multiple bookings;
making a ticketing arrangement for the multiple bookings; and
adding contact information to the multiple bookings.

10. A system for managing passengers of a transportation carrier, comprising:
a booking module for creating multiple bookings, each scheduling one or more passengers to receive one or more services provided by the transportation carrier;
a storage facility to store the multiple bookings;
one or more user interface modules coupled to the storage facility to retrieve at least two of the multiple bookings, to merge the at least two bookings, and to allow an operation to be simultaneously performed on the retrieved bookings at once as though the retrieved bookings were a single booking.

11. The system of claim 10, and including at least one other module coupled to the booking module to perform the simultaneous operation for all of the retrieved booking at once.

12. The system of claim 11, wherein the at least one module is selected from a group consisting of:
a space module to reserve space on a route provided by the transportation provider;
a seats module to assign one or more seats on a route provided by the transportation provider; and
a re-booking module to re-booking space on a route provided by the transportation provider for re-accommodation purposes.

13. The system of claim 10, wherein the booking module updates each of the retrieved bookings during a single database transaction to record the results of the operation.

14. The system of claim 10 wherein the booking module causes each of the retrieved bookings to be cross-referenced with one another.

15. The system of claim 10, wherein the booking module includes logic to retrieve a booking, determine whether the retrieved booking has been previously cross-referenced to one or more other bookings, and if so, to allow processing to be initiated for the retrieved booking and all cross-referenced bookings at once.

16. The system of claim 10 wherein the one or more user interface modules allow a user to identify the at least two of the multiple bookings by specifying any one or more of multiple predetermined searchable fields of the booking.

17. The system of claim 10, wherein the storage facility includes a relational database.

18. A system for managing passengers of a transportation carrier, comprising:
database means for storing multiple bookings, each scheduling one or more passengers for a trip; and,
user interface means for retrieving at least two of the multiple bookings, for visually merging information for the retrieved bookings on a display screen, and for allowing an operation to be simultaneously initiated on all of the retrieved bookings at once.

19. The system of claim 18, wherein the operation is selected from a group consisting of:
placing passengers of the multiple bookings on the same transportation route;
assigning seats so that one or more of the passengers of the multiple bookings may sit together;
requesting a special meal for one or more of the passengers of the multiple bookings;
reserving use of a service for one or more of the passengers of the group.

20. The system of claim 18, and further including display means for providing a display screen including information for all of the merged bookings, and for allowing a user to select any one or more operations that may be performed on the merged bookings.
